(19) United States
(12) Patent Application Publication
(10) Pub. No.: US 2026/0157552 A1
(43) Pub. Date: Jun. 11, 2026

(54) Charcuterie Board

(71) Applicant: Victoire Zinhoue Adebiaye, Lincoln, NE (US)

(72) Inventor: Victoire Zinhoue Adebiaye, Lincoln, NE (US)

(21) Appl. No.: 18/969,504

(22) Filed: Dec. 5, 2024

(51) Int. Cl. A47G 23/06; A47G 19/02; A47G 21/02; B26B 3/02

(52) U.S. Cl. CPC A47G 23/0641; A47G 19/02; A47G 21/02; B26B 3/02

(57) ABSTRACT

A charcuterie board comprising a plurality of recessed sections for displaying and serving food items, a plurality of removable bowls interspersed between the recessed sections, also for displaying and serving food items, and a plurality of charcuterie tools which are removably retained within the charcuterie board. The charcuterie board is wheel-shaped with the tools being removably retained about the perimeter of the round board to create the appearance of a ship's wheel, the handles of the charcuterie tools designed as wheel spokes to enhance the aesthetic look of the charcuterie board.

### FIELD OF INVENTION

The present invention relates to charcuterie boards comprising a plurality of recessed compartments and removable bowls interspersed between the recessed compartments, for displaying and serving food item, and a set of charcuterie tools which are removably stored within the charcuterie board.

### BACKGROUND OF THE INVENTION

Cheese boards and charcuterie boards elevate the conventional serving platter when serving a variety of diverse food items including, for example, crackers, cheeses, cured meats, fruits, nuts, olives, pickles, confections as well as accompaniments, such as jams, spreads, and other dipping sauces. In many instances, the cheese or charcuterie board is composed of wood which offers a natural warmth and traditional presentation. Typically, food items are placed directly on the wooden board. As wood is a porous material, oils from the cheeses, cured meats and other items can be absorbed into the wooden board. Thus, the thorough cleaning is required to prevent staining and bacterial growth. In addition to cleaning, wooden boards must be oiled.

### PRIOR ART

The prior art is replete with a variety of shapes, sizes, and designs for cheese boards and charcuterie boards. While most wooden charcuterie boards have a flat top surface to enable the user to be creative in the food presentation, some of these boards have top surfaces which are provided with pre-cut compartments. Numerous cheese and charcuterie boards are available commercially. Some boards include a set of knives, cheese spreaders and even small bowls, which are placed on the board or near the charcuterie. Some cheese boards currently on the market have a round shape, with sub-divided compartments and charcuterie tools, such as WoodPresents' Personalized Round Serving Tray made of oak and having eight removable compartments oak compartments. Picnic Time promotes a cheese board and tool set with the cheese board having a rounded shaped and the tool set being stored within the perimeter edge of the rounded cheese board, but does not have divided compartments or small bowls within the small cheese board. Of much lesser interest, U.S. Patent Application Publication 2009/0136627 A1 relates to a decorative cheese platter having a rectangular shape for multiple cheeses and a process for vacuum sealing the entire platter. And, U.S. Pat. No. 7,618,900 B1 to Acosta and EP 0641678 B1 to Maiworm show wheel covers having several subdivided sections.

Despite the multitude of cheese and charcuterie boards currently available commercially, a need still exists for a charcuterie board which has a top surface subdivided into a plurality of recessed sections for displaying and serving food items, an additional plurality of recessed compartments for receiving small serving bowls and a plurality of slots within the charcuterie board for removably storing a set of charcuterie tools. Such a charcuterie board should be made from a wood material. In addition, the design of the charcuterie board should be configured such that each type of food item is presented separately on the board and different kinds of food items are not in contact with one another. Further, such a charcuterie board should have an aesthetically pleasing appearance.

### SUMMARY OF THE INVENTION

The invention of the present subject matter relates to a charcuterie board comprising a plurality of recessed sections within the top surface of the board, a plurality of recessed compartments within the top surface for removably placing small serving boards, and a plurality of slots for receiving and removably storing a set of charcuterie tools.

Accordingly, it is an object of the present subject matter to provide wheel-shaped charcuterie board having a plurality of recessed sections disposed within the top surface of the charcuterie board, each of the recessed sections having a leaf-like shape.

It is an additional object of the present subject matter to provide a wheel-shaped charcuterie board comprising a removable insert having a plurality of recessed sections disposed with the top surface of the removable insert, the removable insert being dimensioned to fit within the top surface of the charcuterie board.

It is another object of the present subject matter to provide a charcuterie board comprising a plurality of leaf-shaped sections recessed within the top surface of the board and spaced evenly apart from each other.

It is still another object of the present subject matter to provide a charcuterie board further comprising a plurality of compartments recessed within the top surface of the board and interposed between each of the leaf-shaped sections.

It is a yet another object of the present subject matter to provide a charcuterie board having a plurality of recessed compartments which have an arcuate triangular form and are disposed about the perimeter of the top surface of the charcuterie board.

It is a further object of the present subject matter to provide a charcuterie board further comprising a plurality of small serving bowls, each of which being shaped and sized to be removably placed within the recessed compartments.

It is yet a further object of the present subject matter to provide a charcuterie board further comprising a set of charcuterie serving utensils.

It is still a further object of the present subject matter to provide a charcuterie board having a plurality of slots recessed within the perimeter edge of the charcuterie board, each of the plurality slots being configured to receive and removably store the set of charcuterie serving utensils.

It is an additional object of the present subject matter to provide a charcuterie board having a lazy Susan bearing mounted to its bottom surface to permit the charcuterie board to be rotated in a full circle.

It is an additional object of the present subject matter to provide a charcuterie board having an aesthetic pleasing appearance.

It is another object of the present subject matter to provide a charcuterie board having the appearance of a captain's ship wheel.

These and other objects of the present subject matter are accomplished by providing to a charcuterie board comprising a plurality of recessed sections within the top surface of the board, a plurality of recessed compartments within the top surface for removably placing small serving boards, and a plurality of slots disposed within the perimeter edge of the charcuterie board for receiving and removably storing a set of charcuterie serving utensils.

### BRIEF DESCRIPTION OF DRAWINGS

FIG. 1 is a top perspective view of the charcuterie board of the present subject matter.

FIG. 2 is a top perspective view of the charcuterie board of the present subject matter depicting a removable insert and the plurality of recessed compartments.

FIG. 3 is a top view of the charcuterie board of the present subject matter depicting the plurality of slotted openings for receiving a set of charcuterie utensils.

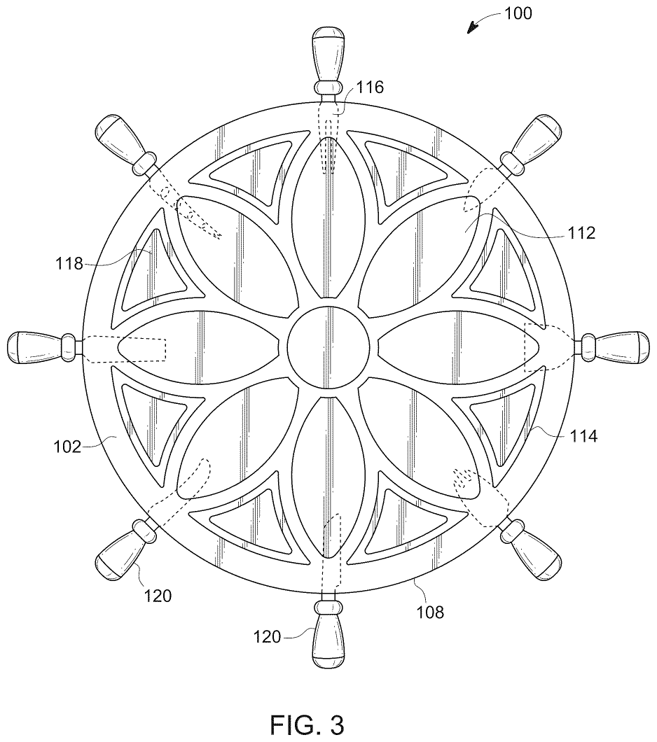

FIG. 4 is a bottom view of the charcuterie board of the present subject matter.

FIG. 5 is a top perspective view of an embodiment of a set of charcuterie tools used with the charcuterie board of the present subject matter.

FIG. 6 is a top perspective view of another embodiment of a set of charcuterie tools used with the charcuterie board of the present subject matter.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

The terms “cheese board”, “charcuterie board, “board”, “serving board”, derivates thereof, and similar terms may be used throughout the specification and it is to be understood that such terms are interchangeable and all refer to the charcuterie board of the present subject matter.

Also, it is to be understood that the phraseology and terminology used herein is for the purpose of description and should not be regarded as limiting. The use of the terms “including”, “comprising”, “having”, and variations thereof herein is meant to encompass the items listed thereafter and equivalents thereof as well as additional items.

Referring to the Figures, a round, wheel-shaped charcuterie board 100 is shown comprising a top surface 102, an outer perimeter 104 disposed along the rounded edge of the top surface, a bottom surface 106 and a perimeter edge 108 disposed between the top surface and the bottom surface. Located within the top surface 102 is a plurality of recessed sections 112, a plurality of recessed compartments 114, and a plurality of slotted openings 116 which are recessed within the perimeter edge 108. The charcuterie board 100 further comprises a plurality of small serving bowls 118 and a set 120 of charcuterie utensil tools. Preferably, the charcuterie board is composed of a wood, more preferably a grained hard wood such as oak or teak. The height of the perimeter edge of the charcuterie board is between from about one-half inch (0.5″) to about two inches (2.0″). More preferably, the height of the perimeter edge is between from about one inch (1.0″) and to about one and one-half inches (1.5″). The diameter of the charcuterie board is between from about twelve inches (12″) to about twenty-four inches (24″).

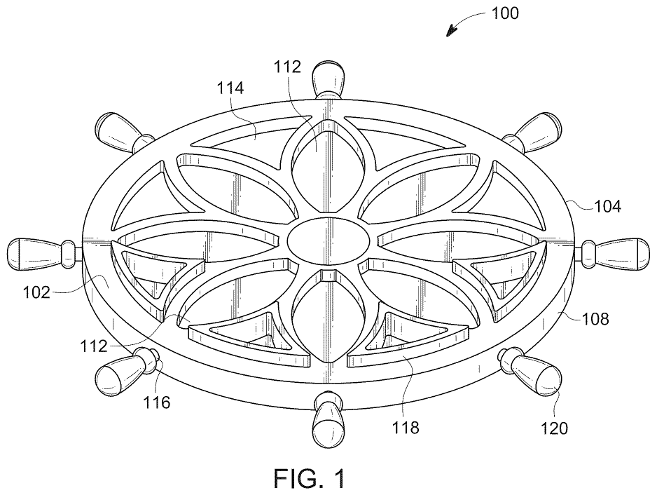

Referring now to FIG. 1, each of the recessed sections 112 are leaf-shaped and are spaced equally apart from each other. In the embodiment shown, eight (8) leaf-shaped recessed sections are shown. However, it is to be understood that the number of recessed sections can be fewer or greater without departing from the spirit of the subject invention. Each of the leaf-shaped recessed sections is designed for a specific food item to be displayed and served, including for example, crackers, cheeses, and cured meats.

Interposed between each of the leaf-shaped recessed sections is a plurality of recessed compartments, each having an arcuate triangular configuration and disposed within the top surface near the outer perimeter 104. In the embodiment shown, eight recessed compartments are shown. However, it is to be understood that the number of recessed compartments can be fewer or greater without departing from the spirit of the subject invention. Each of the recessed compartments is designed to receive a small serving bowl 118 which is configured with the same design and sized as the recessed compartments such that the serving bowl can be removably placed within the recessed compartment. The small serving bowls are ideal for displaying and serving food items such as fruits, nuts, olives, pickles, confections, as well as accompaniments, such as jams, spreads, and other dipping sauces. In FIG. 1, four serving bowls are shown disposed within four recessed compartments. The remaining four recessed compartments are depicted without the serving bowl element solely to better show the recessed compartments. It will be apparent to those skilled in the art that there are eight serving bowls, one each to be disposed in one of the eight plurality of recessed compartments.

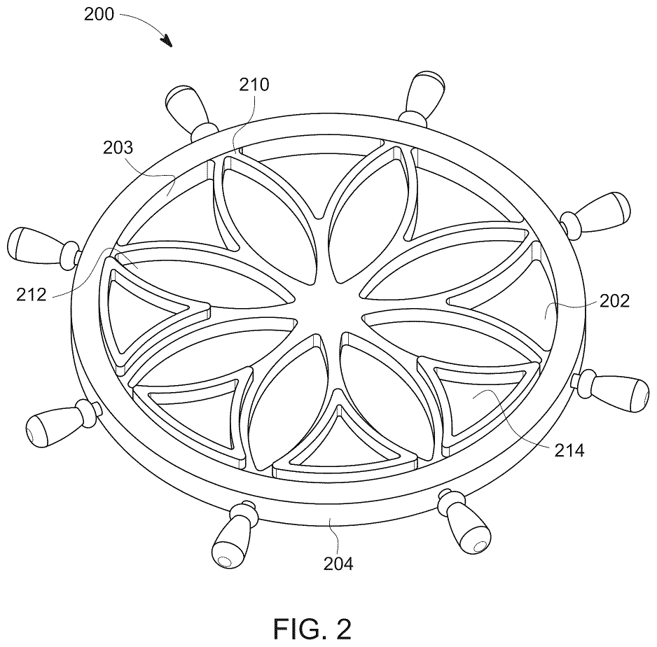

FIG. 2 illustrates an alternate embodiment of the charcuterie board of present subject matter. Rather than top surface 102 being provided with a plurality of recessed sections, the charcuterie board 200 comprises a recessed top surface 202 having an inner perimeter edge 203, an outer perimeter edge 204, and a removable insert 210 having a plurality of leaf-shaped recessed sections 212, the removable insert 212 having an outer diameter which is configured to fit within the inner perimeter edge 204. When the removable insert is placed within the recessed top surface 202 of the charcuterie board, a plurality of recessed compartments 214 are formed for receiving the small serving bowls. In the embodiment shown, the removable insert comprises eight leaf-shaped sections, when placed within the top surface 202, eight recessed compartments are formed.

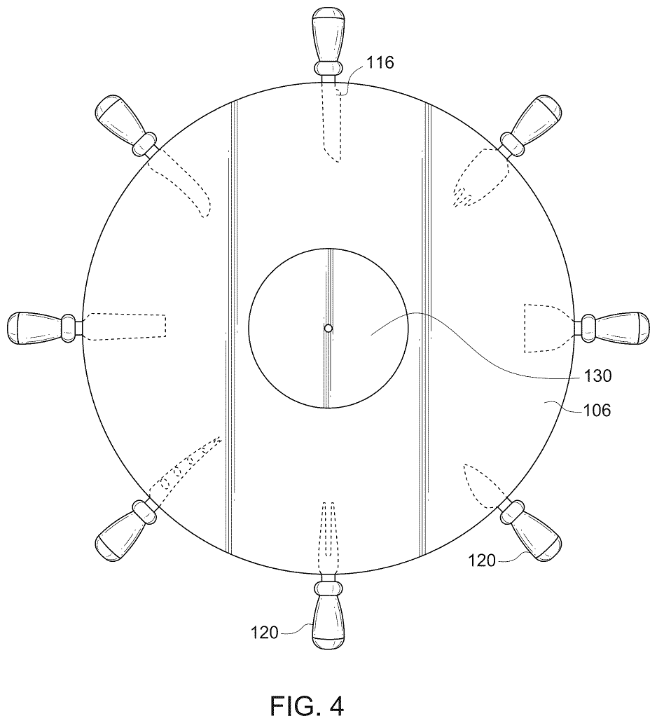

A plurality of recessed slotted openings 116 are disposed within perimeter edge 108, each configured to removably store one member of set of charcuterie utensil tools. Preferably, as shown in FIG. 4, each of the recessed slotted openings are disposed beneath one of each of the plurality of recessed sections 112. Accordingly, in the preferred embodiment, the number of recessed slotted openings equals the number of recessed sections. Each recessed slotted openings is configured to receive and store a charcuterie utensil tools, including for example, a fork-pronged tip tool, a narrow plane knife (sometimes referred to as a flat knife for a range of semi-firm cheeses, a mini-spade knife for cutting hard cheeses, a tear shaped knife for soft cheeses, a wide blade knife for semi-hard cheeses, and cheese spreading knifes of varying width.

Referring to FIG. 4, the bottom surface of the wheel-shaped charcuterie board of the present subject matter further comprises a lazy Susan bearing element 130 mounted to the bottom surface to permit the charcuterie board to be rotated in a full circle.

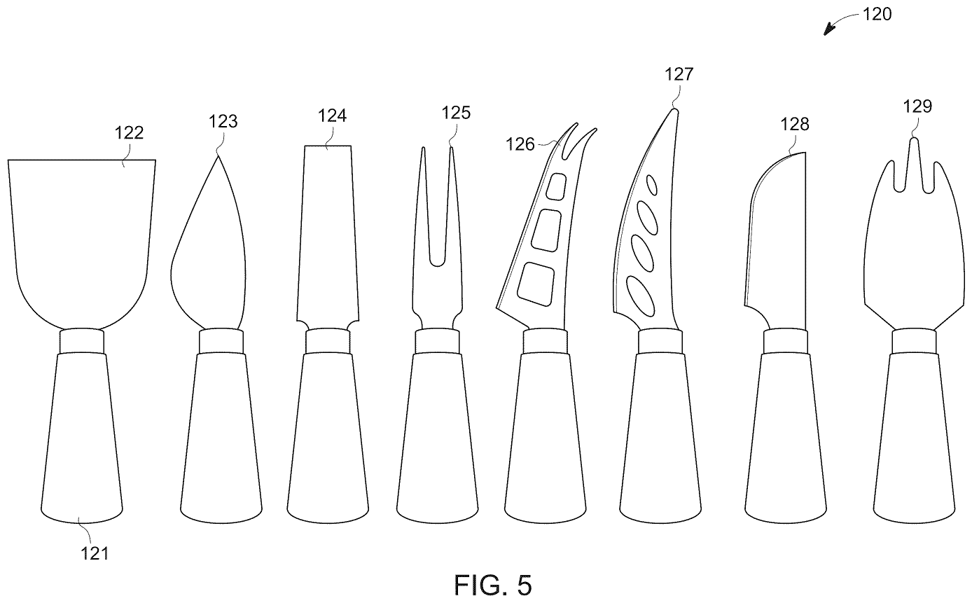

FIG. 5 shows an embodiment of the charcuterie utensil tools 120 of the present subject matter. Each charcuterie utensil tool is provided with a handle 121. In this embodiment, each handle is composed of a marble or faux-marble material which complements the wood of the charcuterie board. When the tools 120 are inserted in the recessed slotted openings 116, the wheel-shaped charcuterie board with the thus inserted handles, has the appearance of a captain's ship wheel. In this embodiment, the set of charcuterie utensil tools include a wide blade knife 122, a narrow plane knife 123, a thin blade knife 124, a mini-fork 125, a first serrated edged knife 126, a second serrated edge knife 127, a cheese spreading knife 128 and a fork-pronged tip tool 129.

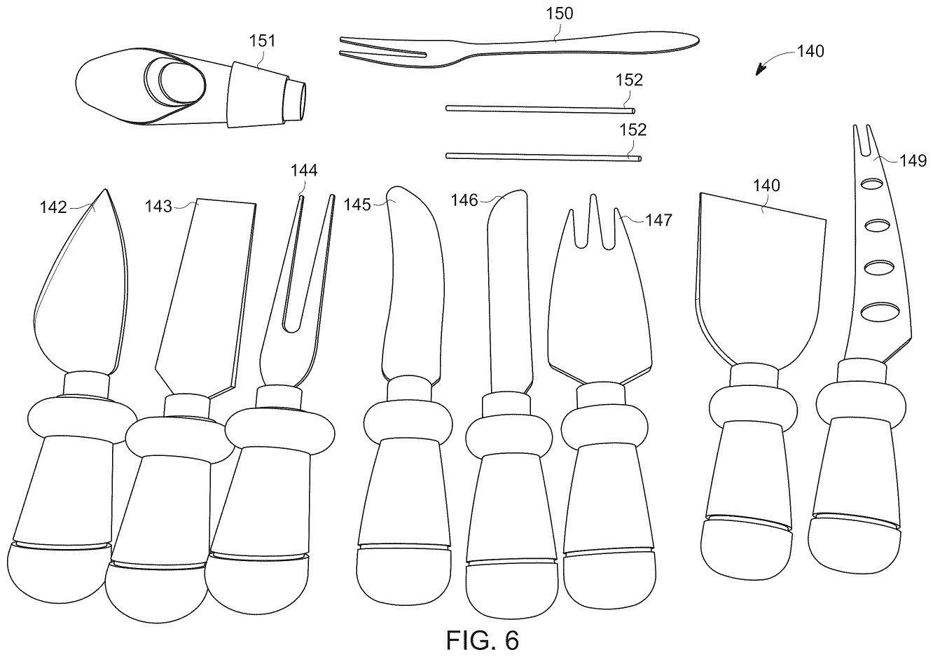

FIG. 6 shows an alternate embodiment of a set 140 of charcuterie utensil tools having a handle 141 composed of wood to match or complement the wood of the charcuterie board. As the earlier embodiment, the effect of the charcuterie board with the tools inserted within the recessed slotted openings with the handles extending outwardly is the appearance of a captain's ship wheel. The set 140 includes a wide plane knife 142, a narrow blade knife 143, a mini-fork 144, a cheese spreading knife 145, a narrow plane knife 146, a fork-pronged tip tool 147, a wide blade knife 148, and a serrated edge knife 149. In this embodiment, other charcuterie tools can be used included an aerator 151, a pickle fork 150 and toothpicks 152.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S.C § 112, sixth paragraph, unless the element is expressly recited using the phrase “means for . . . ” and no method or process step herein is to be construed under those provisions unless the step, or steps, are expressly recited using the phrase “step(s) for . . . .”

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A charcuterie board comprising
a. a top surface having a rounded edge, a plurality of recessed sections equally spaced apart from each other and a plurality of recessed compartments interposed between said recessed sections near the rounded edge;
b. a bottom surface;
c. an outer perimeter disposed along the rounded edge of the top surface, and
d. a perimeter edge disposed between the top surface and bottom surface;
e. a plurality of recessed slotted openings disposed within said perimeter edge and beneath each of said plurality of recessed sections;
f. a plurality of charcuterie utensil tools, each said charcuterie utensil tool having a handle and a tool element end, the tool element end being configured to be removably stored within one of said plurality of recessed slotted openings, and
g. a plurality of serving bowls, each of said plurality of serving bowls configured to be set within one of said plurality of recessed compartments.

2. The charcuterie board in accordance with claim 1, wherein said charcuterie board is wheel-shaped.

3. The charcuterie board in accordance with claim 2, wherein when each of said plurality of charcuterie utensil tools are removably stored within said plurality of recessed slotted openings, said handles extend outwardly from said perimeter edge such that the charcuterie board with the extending handles has the appearance of a captain's ship wheel.

4. The charcuterie board in accordance with claim 1, wherein each of said recessed sections is leaf-shaped and wherein each of said recessed compartments has an arcuate triangular configuration.

5. The charcuterie board in accordance with claim 4, wherein said bottom surface has a lazy Susan bearing mounted thereto.

6. A round-shaped charcuterie board comprising
a. a top recessed surface having an inner perimeter edge and an outer perimeter disposed along the rounded edge of said top recessed surface;
b. a bottom surface;
c. a perimeter edge disposed between the top surface and bottom surface;
d. a removable insert having a plurality of leaf-shaped recessed
sections, said removable insert having an outer diameter which is configured to fit within the inner perimeter edge of said top recessed surface, c
e. a plurality of recessed compartments formed within said recessed top surface when said removable insert is placed within said recessed top surface, said plurality of recessed compartments being interposed between said recessed sections near the rounded edge;
f. a plurality of recessed slotted openings disposed within said perimeter edge
g. a plurality of charcuterie utensil tools, each said charcuterie utensil tool having a handle and a tool element end, the tool element end being configured to be removably stored within one of said plurality of recessed slotted openings, and
h. a plurality of serving bowls, each of said plurality of serving bowls configured to be set within one of said plurality of recessed compartments.
